(19) United States
(12) Patent Application Publication
(10) Pub. No.: US 2024/0047100 A1
(43) Pub. Date: Feb. 8, 2024

(54) BUSHING THROUGH A HOUSING COMPONENT, ESPECIALLY FOR ROUGH ENVIRONMENTS WITH MECHANICAL AND THERMAL STRESS

(71) Applicant: Schott AG, Mainz (DE)

(72) Inventors: Helmut Hartl, Klosterneuburg (AT); Reinhard Ecker, Landshut (DE); Christian Mix, Landshut (DE)

(73) Assignee: Schott AG, Mainz (DE)

(21) Appl. No.: 18/491,459

(22) Filed: Oct. 20, 2023

Related U.S. Application Data
(63) Continuation of application No. PCT/EP2022/058551, filed on Mar. 31, 2022.

(30) Foreign Application Priority Data
Apr. 21, 2021 (DE) 10 2021 110 048.8
Mar. 31, 2022 (WO) PCT/EP2022/058551

(51) Int. Cl. H01B 7/40; F01N 13/18; F02B 39/00; B01D 53/94

(52) U.S. Cl. CPC H01B 7/40; F01N 13/1805; F02B 39/00; B01D 53/94; B01D 2258/01

(57) ABSTRACT

A feedthrough in a housing component that is subject to thermal loading for a functional assembly includes: an inner conductor; an outer conductor having a sleeve assigned to or formed on the outer conductor that retains or makes it possible to fasten the feedthrough to the housing component; and an electrically insulating component between the outer conductor and the inner conductor, the electrically insulating component retaining the inner conductor relative to the outer conductor in an electrically insulated fashion.

### CROSS REFERENCE TO RELATED APPLICATIONS

This is a continuation of International Patent Application No. PCT/EP2022/058551 filed on Mar. 31, 2022, which is incorporated in its entirety herein by reference. International Patent Application No. PCT/EP2022/058551 claims priority to German Patent Application No. 10 2021 110 048.8 filed on Apr. 21, 2021, which is incorporated in its entirety herein by reference.

### BACKGROUND OF THE INVENTION

### 1. Field of the Invention

The invention relates to a feedthrough in a housing component, in particular for harsh environments subject to mechanical and thermal loading.

### 2. Description of the Related Art

Where such feedthroughs, for example for the passage of electrical or electronic signals, are located in portions of exhaust gas systems of internal combustion engines, for example in the case of motor vehicles with regulated exhaust gas purification, greatly variable environmental conditions frequently occur.

DE 10 2011 101 676 B4, for example, describes a catalytic-converter heating system for an internal combustion engine of a motor vehicle that comprises a monitoring module, a mode selection module and a control module for an electrically heated catalytic converter (EHC), wherein the mode selection module is configured such that it takes a first temperature and/or the active catalyst volume as a basis for selecting an EHC heating mode and generates a mode signal, which the EHC control module takes as a basis for conducting a current to an electrically heated catalytic converter (EHC) of the catalytic converter arrangement, which causes the latter to heat up.

Such systems can make use of high current intensities of for example 20 A to 100 A in order to make in particular high heating outputs available, these typically lying in a range from 1 kW to approximately 8 kW. The high heating outputs should serve to quickly heat up the electrically heated catalytic converter (EHC), in order to keep a cold-start or cold-running phase as short as possible.

These currents are conducted into the catalytic converter by electrical feedthroughs, these feedthroughs generally comprising an inner conductor which is retained inside an associated outer conductor by an electrically insulating material, and the outer conductor in turn is attached to the housing of the respective catalytic converter and electrically conductively connected to this housing.

Document DE 10 2008 045 816 A1 proposes, for a feedthrough, an elastomer material surrounding a conductor, in order to increase a creepage distance, which in the context of this disclosure is the distance along which creepage currents can form between the joined parts. A disadvantage of this solution is that elastomer materials often do not have the sustained operational integrity and thermal stability required for the hot region of exhaust gas systems, since temperatures of up to more than 900° C. can arise inside these catalytic converters and thus form a very high temperature gradient in relation to the outside of the catalytic converter.

In the case of feedthroughs to exhaust-gas catalytic converters or to turbochargers of internal combustion engines, temperature gradients of several 100 K may well arise between the outer conductor and the inner conductor of the feedthrough.

There is also the fact that exhaust-gas-conducting systems are exposed to intense fluctuating-temperature loading, for example when there is a changeover from the cold-start or cold-running phase to a desired sustained operating state or when the respective internal combustion engine is being turned off, which leads to the generation of thermally induced stresses, in particular in the event of inhomogeneous cooling of the respective exhaust-gas element.

EP 3 650 415 A1, which is by the same applicant, describes a joined connection comprising a crystallized glass which retains an inner conductor relative to an outer conductor, the joined connection being usable as electrical current feedthrough in an element of an exhaust gas system. However, specifications as to the mounting or mechanical retention of this joined connection are not disclosed.

The feedthroughs discussed above are furthermore also in another respect exposed to a harsh environment, since corrosive exhaust gases act on the feedthrough inside a catalytic converter, in particular an electrically heated catalytic converter, and salt water or mechanically aggressive particles frequently come into contact with the feedthrough in outer regions of the catalytic converter.

There is often also the occurrence of high mechanical loading as a result of vibrations, which can correspond to accelerations of up to considerably more than 10 g. The resulting forces may be introduced into the outer conductor through the fastener for fastening the feedthrough to the catalytic converter, the fastener retaining the pin of the inner conductor, and the pin often leads to heating elements inside the catalytic converter and is thus exposed to yet further, additional mechanical loading through these heating elements in the exhaust gas flow. For example, it is also possible for the pulsating exhaust gas flow itself to generate frequency spectra which can introduce undesired movements into the fastener for the feedthrough in the case of an elastic, in particular oscillatory fastener.

WO 2018/114392 A2, which is by the same applicant, proposes a feedthrough for a battery or capacitor housing, optionally for a supercapacitor housing, comprising a main body, in the case of which the main body is provided with at least one opening, which retains at least one functional element in a glass or glass ceramic material, and is intended for connection to a housing of a light metal, in particular aluminum, wherein the main body at least partially consists of a light metal, optionally a light-metal alloy. Batteries, capacitors and in particular also supercapacitors, however, are generally not faced with the harsh environmental conditions described above, but rather must actually usually avoid very high temperatures already owing to the chemical substances used in them. Insofar as accumulators are used in the drive technology of motor vehicles, increased attention must be given to managing their temperature, in particular also to ensure that they do not enter operating states which run the risk of fire or explosion and then entail danger to life and limb of the vehicle occupants.

However, even without the aforementioned loading during operation of an internal combustion engine, there is already the risk of preliminary damage to the feedthrough, for example when it is being mounted on a housing component of a catalytic converter. If, for example, the outer conductor of the feedthrough is welded to the housing component of the catalytic converter, in this respect locally high temperatures that arise and resulting stresses can cause damage to the temperature-stable, optionally mineral material that retains the inner conductor, even without it being necessary to identify this damage immediately. Such preliminary damage may well, however, considerably reduce the sustained operational integrity of the feedthroughs discussed above.

What is needed in the art is a way of at least alleviating the disadvantages set out above. In particular, it is advantageous to be able to ensure the integrity of a feedthrough with greater reliability than before already when the feedthrough is being mounted.

Furthermore, mechanically robust mounting of a feedthrough, in particular in the exhaust gas system of an internal combustion engine, is also advantageous for its sustained operational integrity.

### SUMMARY OF THE INVENTION

In some embodiments provided according to the invention, a feedthrough in a housing component that is subject to thermal loading for a functional assembly includes: an inner conductor; an outer conductor having a sleeve assigned to or formed on the outer conductor that retains or makes it possible to fasten the feedthrough to the housing component; and an electrically insulating component between the outer conductor and the inner conductor, the electrically insulating component retaining the inner conductor relative to the outer conductor in an electrically insulated fashion.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a cross-sectional illustration through an exemplary embodiment of a feedthrough provided according to the invention which is retained on a housing component that is subject to thermal loading, in particular a functional assembly of the exhaust gas system of a motor vehicle, wherein the cross-sectional plane extends horizontally approximately through the line of symmetry of the feedthrough;

FIG. 2 shows a cross-sectional illustration through another exemplary embodiment of a feedthrough provided according to the invention which is retained on a housing component that is subject to thermal loading, in particular a functional assembly of the exhaust gas system of a motor vehicle, wherein the cross-sectional plane extends horizontally approximately through the line of symmetry of the feedthrough;

FIG. 3 shows a cross-sectional illustration through a non-inventive embodiment of a feedthrough which is retained on a housing component that is subject to thermal loading, in particular a functional assembly of the exhaust gas system of a motor vehicle, wherein the cross-sectional plane extends horizontally approximately through the line of symmetry of the feedthrough;

FIG. 4 shows a cross-sectional illustration through the feedthrough shown in FIG. 3, illustrating temperatures like those that can arise during laser welding or tungsten inert gas (TIG) welding for connecting the feedthrough to a functional assembly of the exhaust gas system of a motor vehicle;

FIG. 5 shows a plan view of a 3D illustration obliquely from above, in which the temperatures arising during laser welding or TIG welding are shown for the embodiment illustrated in FIG. 1 when it is being mounted on a functional assembly of the exhaust gas system of a motor vehicle;

FIG. 6 shows a cross-sectional illustration through the exemplary embodiment of the feedthrough shown in FIG. 1 which is retained on a housing component that is subject to thermal loading, in particular a functional assembly of the exhaust gas system of a motor vehicle, wherein the cross-sectional plane extends horizontally approximately through the line of symmetry of the feedthrough and the temperatures arising during laser welding or TIG welding when the feedthrough is being mounted on a functional assembly of the exhaust gas system of a motor vehicle are shown;

FIG. 7 shows a cross-sectional illustration through the exemplary embodiment of a feedthrough shown in FIG. 2, in which a weight has been attached to the inner conductor that makes it possible to introduce vibration stresses into the feedthrough, the cross-sectional plane extending horizontally approximately through the line of symmetry of the feedthrough;

FIG. 8 shows a cross-sectional illustration of simulated vibration loading of the exemplary embodiment shown in FIG. 2, in which, as illustrated in FIG. 7, a weight is attached to the inner conductor that makes it possible to introduce vibration stresses into the feedthrough, together with the results of the vibration loading;

FIG. 9 shows an enlarged view of a detail from FIG. 8 in the region of the transition from the outer conductor to the sleeve;

FIG. 10 shows a cross-sectional illustration through another exemplary embodiment of a feedthrough provided according to the invention which is retained on a housing component that is subject to thermal loading, in particular a functional assembly of the exhaust gas system of a motor vehicle, wherein the cross-sectional plane extends horizontally approximately through the line of symmetry of the feedthrough;

FIG. 11 shows a cross-sectional illustration through a detail of the feedthrough shown in FIG. 10, illustrating temperatures like those that can arise during laser welding or TIG welding for connecting the feedthrough to a functional assembly of the exhaust gas system of a motor vehicle;

FIG. 12 shows a cross-sectional illustration through the outer conductor and the sleeve of another exemplary embodiment provided according to the invention with a projecting bottom region of the sleeve, in which the sleeve is retained on the outer conductor by laser welding or a soldered connection, the cross-sectional plane extending horizontally approximately through the line of symmetry of the feedthrough;

FIG. 13 shows a cross-sectional illustration through the outer conductor and the sleeve of another exemplary embodiment provided according to the invention with a radially narrowed portion in the region of the first mounting portion of the sleeve, in which the sleeve is retained on the outer conductor by laser welding or a soldered connection;

FIG. 14 shows a cross-sectional illustration through the outer conductor and the sleeve of another exemplary embodiment provided according to the invention with a projecting bottom portion and a radially narrowed portion in the region of the first mounting portion of the sleeve, in which the sleeve is retained on the outer conductor by laser welding;

FIG. 15 shows a cross-sectional illustration through the outer conductor and the sleeve of another exemplary embodiment provided according to the invention with a projecting bottom region and a radially narrowed portion in the region of the first mounting portion of the sleeve, in which the sleeve is retained on the outer conductor by a soldered connection;

FIG. 16 shows a cross-sectional illustration through the outer conductor and the sleeve of another exemplary embodiment with a radially narrowed portion in the region of the first mounting portion of the sleeve, in which the sleeve is retained on the outer conductor by a press fit and/or by mechanical pressing elements, in particular by recesses at certain points or certain regions of the sleeve in the radially inward direction; and

FIG. 17 shows a cross-sectional illustration through the outer conductor and the sleeve of another exemplary embodiment provided according to the invention with a radially narrowed portion in the region of the first mounting portion of the sleeve, in which the sleeve is retained on the outer conductor by laser connections at certain points.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The inventors have found that, surprisingly, even in the case of high-temperature-resistant feedthroughs, preliminary damage which is not always immediately identifiable but can considerably reduce the sustained operational integrity of these high-temperature feedthroughs can already occur when the latter are being mounted, for example, by laser or tungsten-inert gas (TIG) welding.

According to the invention, it is provided that a feedthrough in a housing component, in particular for harsh environments subject to mechanical and thermal loading, comprises: an inner conductor, an outer conductor and an electrically insulating component between the outer conductor and the inner conductor, wherein the electrically insulating component between the outer conductor and the inner conductor optionally comprises a glass, in particular a crystallizable or at least partially crystallized glass, or a glass ceramic and the electrically insulating component retains the inner conductor relative to the outer conductor in electrically insulated fashion. In a further configuration, a sleeve is assigned to or is formed on the outer conductor and retains or makes it possible to fasten this feedthrough to a housing component that is subject to thermal loading, in particular to a functional assembly of the exhaust gas system of a motor vehicle.

The environments subject to thermal loading under consideration are environments in which recurring temperature differences of more than 200 K can occur in the operating state of the housing component subject to thermal loading, as is usually the case in exhaust gas systems of internal combustion engines.

Harsh environments subject to mechanical and thermal loading under consideration are environments which exhibit, in addition to the recurring temperature differences described above, mechanical loading, such as vibrations, which exert active acceleration forces of at least 10 g, thus ten times the acceleration acting in the earth's gravitational field, on the feedthrough.

Within the meaning of the present disclosure, a feedthrough is considered to be “fastenable” when it is suitable and intended for fastening to a further assembly, for example by a mounting region provided on a sleeve formed by the feedthrough or assigned to the feedthrough for the purpose of fastening said sleeve.

Retained by an electrically insulating component or retained in electrically insulated fashion, within the context of the present disclosure, refers to a manner of retaining in which a DC resistance between the parts to be joined, in a dry atmosphere, of the feedthrough described above, thus between the inner conductor and the outer conductor of the feedthrough, on which there are no deposits which might impair this resistance, is more than 100 mohm, these electrical resistance values being measured at voltages of less than 100 V.

The invention makes it possible to enable mounting or fastening, using welding processes, of the insulating component, in particular the vitrification frequently provided by this component, for example owing to inhomogeneous mechanical stress distribution during a welding process, without damage.

In this respect, vitrification of the insulating component, which usually has a high modulus of elasticity and is less elastic than metals of the inner or outer conductor, may be advantageously decoupled from deformation of the outer conductor when the welding process is being applied.

In addition, it is possible to provide damping of the deflection of the inner conductor, which is in the form of a pin, relative to the outer conductor with respect to vibration occurring in the operating state, this vibration being described in more detail below.

Providing a sleeve enables the use of suitable wall thicknesses, which can be thicker for the outer conductor surrounding the insulating component and thinner for mounting regions, in particular welding regions, on the sleeve. Overall, the inner conductor can react more elastically to mechanical loading.

In some embodiments, the outer conductor is formed in one piece with the sleeve. Within the context of the present disclosure, embodiments in which the outer conductor is formed in one piece with the sleeve are also abbreviated merely as “one-piece embodiments”.

Further embodiments have an at least two-piece form, for which advantageously different materials can be used for the outer conductor and the sleeve. In this respect, a selectively set elasticity of the sleeve, in particular a corresponding selection of the material and also the wall thickness and the axial extent of the sleeve, also makes it possible to absorb differences in thermal expansion between the feedthrough and the component to which it is fastened without damaging, thermally induced differences in stress having to arise. In this respect, it can primarily be advantageous to adapt the thermal expansion of the outer conductor to that of the glass-ceramic insulation. This may be advantageous in terms of the alternating temperature loading occurring in application, since stresses in the glass-ceramic insulation material are thus minimized.

In some cases, it may also be advantageous to adapt the material of the sleeve independently of the outer conductor to the welding partner to which the feedthrough is fastened, in order to optimize this process.

Within the context of the present disclosure, embodiments in which the outer conductor and the sleeve are two pieces are also abbreviated merely as “two-piece embodiments”, even if, after it has been mounted, the sleeve is retained mechanically fixedly on the outer conductor, for example, by a first mounting region.

A hermetically sealed connection which enables inexpensive series manufacture, in particular using non-cutting, thus non-machining, production, can be realized by welding or soldering.

Optionally, the inner conductor has a cylindrically symmetrical, in particular cylindrical, form and the outer conductor surrounds the inner conductor in a cylindrically symmetrical, in particular annular, arrangement, since this results in a compact and mechanically stable configuration.

In the case of a two-piece configuration, the sleeve can advantageously surround the outer lateral surface of the outer conductor and have at least two spatially separate mounting regions.

In this respect, a first mounting region can provide a mechanical connection between the sleeve and the outer conductor and a second mounting region can provide a mechanical connection between the sleeve and the housing component of the functional assembly of the exhaust gas system of a motor vehicle, on which housing part the feedthrough is retained after being mounted.

It may be advantageous here if different fastening forms can be selected for the first mounting region than for the second mounting region, as will be described in more detail below with reference to various embodiments with their fastening or mounting options.

It may also be advantageous if, after the sleeve has been mounted on the outer conductor of the feedthrough, a gap is formed between the outer lateral surface of the outer conductor and an inner surface of the sleeve. In that case, during the mounting, for example, by laser or tungsten inert gas (TIG) welding, heat can be dissipated very effectively and in the mounted state of the feedthrough there is a free space, which enables elastic deflections of the feedthrough without mechanical contact and resulting damage. Force peaks that are introduced for example into the inner conductor, which is in the form of a pin, can also be absorbed by this configuration effectively without mechanical damage.

Such a configuration of the sleeve makes it possible to relatively freely select the axial width of the fastening regions and, furthermore, multiple fastening lines one on top of the other are also enabled, for example to provide a defined mechanical strength and a reduced tendency to oscillate, in particular oscillate in resonant fashion.

If the sleeve has a radially narrowed portion in the region of the first mounting portion, this can have several advantages, for example when, as a result of this narrowed mounting portion, a press fit for the outer lateral surface of the outer conductor is provided and this press fit can retain the outer conductor relative to the sleeve already reliably and with sustained operational integrity.

Furthermore, such a tight fit between the sleeve and the outer lateral surface of the outer conductor also enables resistance and friction welding, in order to retain the sleeve on the outer conductor with sustained operational integrity in this way.

In addition, laser and TIG welding is also more specifically enabled, since in that case corresponding weld seams can have a more secure design and a hermetically sealed connection between the sleeve and the outer conductor can also then be produced with high reliability.

The friction effect provided by the radially narrowed portion of the sleeve in relation to the outer lateral surface of the outer conductor can also act as a damping member, for example with respect to torsional, tilting and longitudinal oscillations of the outer conductor relative to the sleeve retained in a housing component.

Therefore, the first mounting region, which provides a mechanical connection between the outer conductor and the sleeve, in the mounted state can be formed by a press fit or local mechanical pressing elements, in particular by recesses at certain points or certain regions of the sleeve in the radially inward direction.

What is advantageous in this case is that the coefficient of thermal expansion of the material of the outer conductor is the same as, or at least in the respective operating temperature range only slightly greater than, the coefficient of thermal expansion of the material of the sleeve, since in that case heating of the feedthrough does not generate any forces which attempt to separate the sleeve from the outer conductor, but instead additional forces are introduced into the feedthrough which allow the mechanical connection between the outer conductor and the feedthrough to be more stable. What is advantageous here is a difference in the thermal expansion, thus in the respective coefficient of thermal expansion, of less than 3 ppm/K, such as less than 1.5 ppm/K.

It may be advantageous if, in the case of the previously mentioned two-piece design, the first mounting region is formed on the inner surface of the sleeve and the second mounting region is formed on an outer lateral surface of the sleeve, and, in the case of the one-piece embodiment, the at least one mounting region is formed on the outer lateral surface of the sleeve. This arrangement of the second or the at least one mounting region makes it possible to ensure that possibly high local temperature peaks resulting during the mounting lead only to greatly reduced heating of the outer conductor and, even in the event of it being heated, act only on locally greatly enlarged regions, with the result that only considerably smaller thermally induced stresses are generated between the outer conductor and the insulating component.

This can be the case in particular when the second mounting region, which provides a mechanical connection to the housing component of the functional assembly of the exhaust gas system of a motor vehicle, in the mounted state is connected to the housing component of the functional assembly of the exhaust gas system of a motor vehicle by a soldered connection or a welded connection, in particular a laser- or TIG-welded connection or by resistance welding.

It may be advantageous if, in the case of two-piece embodiments, the first mounting region, which provides a mechanical connection between the outer conductor and the sleeve, in the mounted state can be formed by a soldered connection or a welded connection, in particular a resistance-welded, friction-welded, laser-welded or TIG-welded connection or by friction welding, since in this case, as a result of the sleeve, heat is dissipated and heat acting on the outer conductor can be locally distributed to a greater extent.

If, in the case of two-piece embodiments, the second mounting region is radially and/or axially offset relative to the first mounting region, or, in the case of one-piece embodiments, the at least one mounting region is radially and/or axially offset in relation to the region in which the outer conductor merges into the sleeve, the radial or the axial offset makes it possible to influence heat-conducting transitions between the sleeve and the outer conductor with further definition.

In general, a fastener on the first mounting region can have a radially encircling form and an annularly closed fastening line formed on the first mounting region here is offset in relation to the lower and the upper radial ends of the sleeve, and in particular as a result of their position in the axial direction have a damping effect on torsional, tilting and longitudinal oscillations, for example if this fastening line eliminates a possible oscillation antinode.

To this end, it is also possible for the second mounting region formed on an outer lateral surface of the sleeve, or the at least one mounting region, to have an encircling form and an annularly closed fastening line formed on the second mounting region is offset in relation to the lower and upper radial ends of the sleeve.

The feedthrough described here can advantageously be fastened to a functional assembly of a motor vehicle, such as to an exhaust-gas catalytic converter, in particular an electrically heated exhaust-gas catalytic converter (EHC) or to an exhaust-gas catalytic converter comprising sensors.

As an alternative or in addition, the feedthrough described here can also be retained on a turbocharger, in particular a turbocharger provided with an electric drive or a turbocharger comprising sensors, with sustained operational integrity.

Furthermore, the housing component which is subject to thermal loading and on which the feedthrough is retained may also be part of a chemical production plant.

The invention will be described in more detail below on the basis of exemplary embodiments and with reference to the appended drawings.

In the following detailed description, the same reference signs denote constituent parts that are the same or have the same effect in the various respectively disclosed embodiments. Only for the sake of better understanding are not all the illustrations shown true to scale.

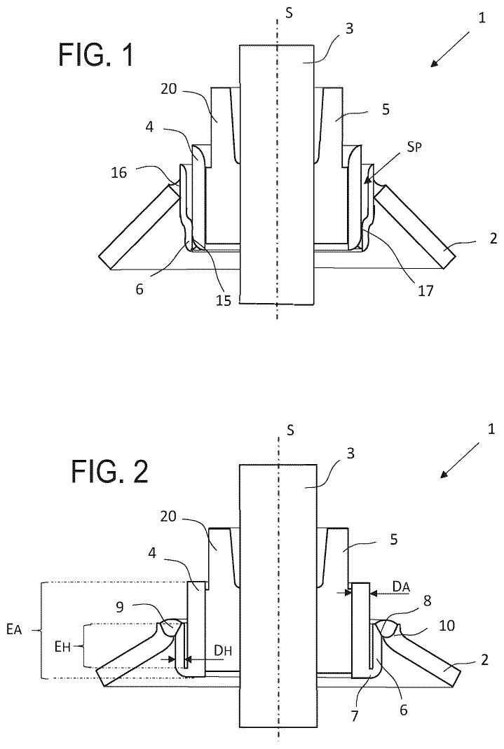

Reference is made below to FIG. 1, which shows a cross-sectional illustration through an exemplary embodiment of a feedthrough, provided with the reference sign 1 overall, in a housing component 2, this cross-sectional illustration extending horizontally approximately through the line of symmetry S of the feedthrough 1.

The housing component 2 may be part of an assembly that is subject to thermal loading, in particular a functional assembly of the exhaust gas system of a motor vehicle, such as an exhaust-gas catalytic converter, in particular an electrically heated exhaust-gas catalytic converter (EHC) or an exhaust-gas catalytic converter comprising sensors, or part of a turbocharger, in particular a turbocharger provided with an electric drive or a turbocharger comprising sensors.

As an alternative, in further embodiments the housing component 2 that is subject to thermal loading may also be part of a chemical production plant, in order for example to conduct electrical signals through the housing component 2 to or from sensors or actuators by the feedthrough 1.

The feedthrough 1 generally comprises an inner conductor 3, an outer conductor 4, and an electrically insulating component 5 between the outer conductor 4 and the inner conductor 3.

The electrically insulating component 5 may comprise a glass, in particular a crystallizable or at least partially crystallized glass, or a glass ceramic and retains the inner conductor 3 relative to the outer conductor 4 electrically insulated from the latter and in mechanically fixed fashion, in particular with sufficient strength to resist being pulled apart and vibration resistance for the respective application, this being ensured depending on the application by its respective structural dimensions and material selection.

In this respect, when the feedthrough 1 is being manufactured, the electrically insulating component 5 may be brought into its molten state at least in certain regions by heating, while it is already substantially in its later operating position between the likewise heated inner conductor 3 and the heated outer conductor 4, and at this elevated temperature wet both the outer lateral surface of the inner conductor 3 and the inner surface of the outer conductor 4, which is also referred to as glass fusion. Cooling of the inner conductor 3, the electrically insulating component 5 and the outer conductor 4, which is effected after the wetting, leads to a mechanically stable connection between the inner conductor 3 and the insulating component 5 and also between the insulating component 5 and the outer conductor 4, which is also referred to as vitrification. If the outer conductor 4 has a higher coefficient of thermal expansion than the insulating component 5 and the pin, during the cooling this gives rise to compressive stresses that are exerted on the insulating component 5 by the outer conductor 4 and lead to an increase in strength of the feedthrough 1 and in particular also increase the strength of the inner conductor 3 to resist being pulled apart. In this case, the resulting vitrification is also referred to as compressive vitrification.

In general, the inner conductor 3 has a cylindrically symmetrical, in particular cylindrical, form, for example has the form of a cylindrical pin, wherein in further embodiments the inner conductor 3 can also have a column-shaped form with a cross section which does not exhibit cylindrical symmetry, and the outer conductor 4 surrounds the inner conductor 3 cylindrically symmetrically and in particular has an annular or tubular form.

A sleeve 6 is assigned to or formed on the outer conductor 4 and retains the latter and thus the feedthrough 1 on the housing component 2 or makes it possible to fasten them to the housing component 2.

In the embodiments illustrated in FIGS. 2, 5, 6, 7, 8 and 9, the sleeve 6 has a substantially cylindrical form and, in each case at its lower end, has a radially inwardly extending bridge portion 7 which connects it to the outer conductor 4 in one piece.

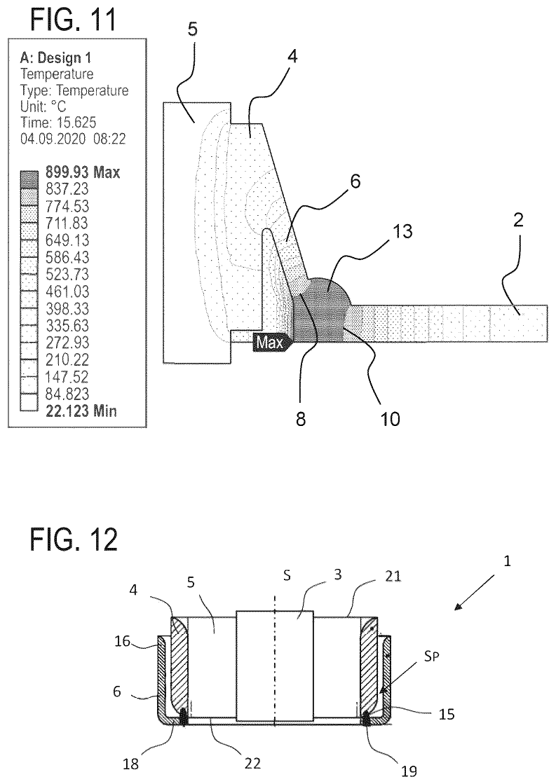

In the embodiments illustrated in FIGS. 10 and 11, the sleeve 6 extends frustoconically away from the top part of the outer conductor 4 and widens radially downward, but is likewise formed in one piece with the outer conductor.

In these one-piece embodiments described here, both the outer conductor 4 and the sleeve 6 consist of the same material, for example metal, in particular iron, an iron alloy, an iron-chromium alloy, an iron-chromium-nickel alloy, an iron-nickel alloy or an iron-nickel-cobalt alloy, Kovar, titanium, a titanium alloy, in particular a metal from the group of steels, for example standard steels, stainless steels, nonrusting steels and high-temperature-stable ferritic steels, which are also known under the trade name Thermax, for example Thermax 4016, Thermax 4742, or Thermax 4762 or Crofer22 APU or Crofer22 H or NiFe-based materials, for example NiFe45, NiFe47 or those known under the trade name Inconel, for example Inconel 718 or X-750, or steels known for example under the designations CF25, Alloy 600, Alloy 625, Alloy 690, SUS310S, SUS430, SUH446 or SUS316, or austenitic steels such as 1.4828 or 1.4841, aluminum, an aluminum alloy, AlSiC, magnesium or a magnesium alloy.

In these one-piece embodiments, in which the sleeve 6 is formed in one piece with the outer conductor 4, the sleeve 6 has at least one annular mounting region 8 on which, when the sleeve has been mounted on the housing component 2, it is retained by a laser or TIG welded connection. An annular laser weld seam or TIG weld seam 9 extends along the mounting region 8 to a mounting region 10 correspondingly formed on the housing assembly 2 and connects the sleeve 6 to the housing component 2 in this way.

In this respect, as is also the case in the embodiments presented in more detail below, fastening by welding without damage to a vitrification of the insulating component 5 by inhomogeneous stress distributions during the respective welding process is advantageously enabled.

During the welding operation, the insulating component 5 is subject to less thermal loading and the entire vitrification of the insulating component 5, which generally has a high modulus of elasticity and is less elastic than metals, is decoupled in particular from deformations of the outer conductor relative to the insulating component 5.

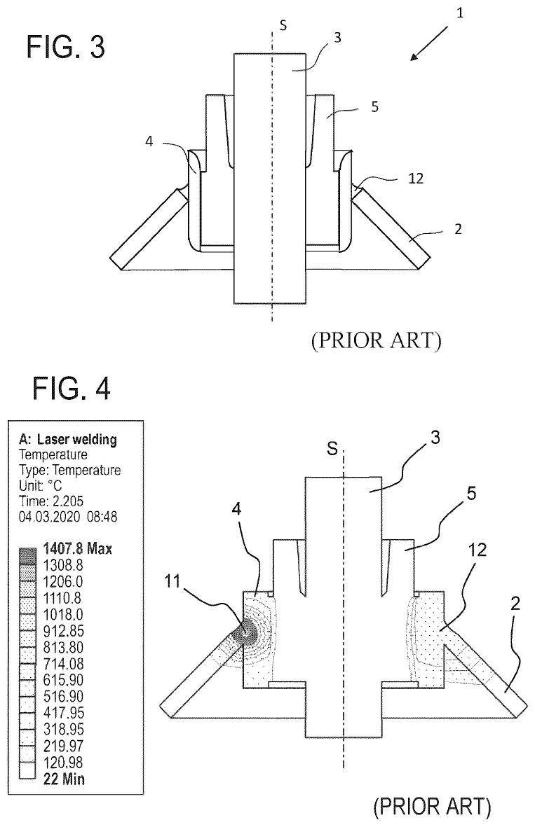

This subject matter is particularly discernible in comparison with the conventional embodiment illustrated in FIGS. 3 and 4, in the case of which, immediately after the welding and directly in the region of the weld point 11 of the conventional weld seam 12 in the regions of the inner wall of the outer conductor 4 that are adjacent to the weld point 11, there are very high temperatures Tmax of above 950° C., even up to 1019° C., during TIG welding and above 600° C. during laser welding, which act on the insulating component 5 in respectively locally delimited fashion.

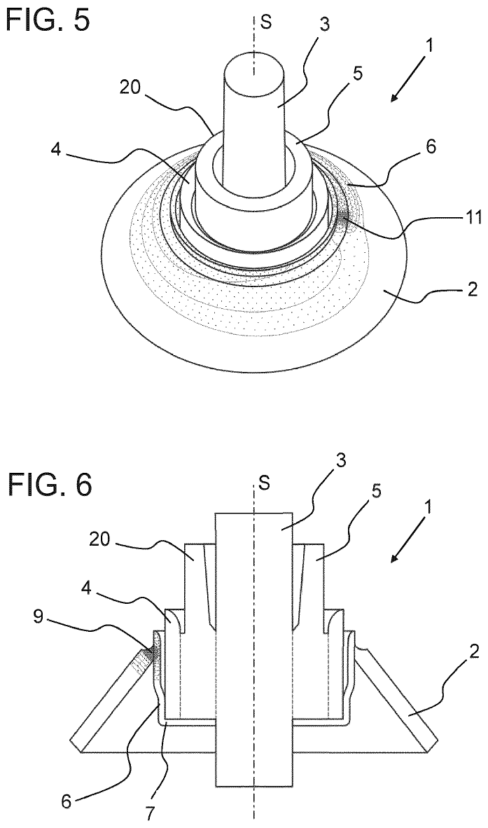

These locally delimited, very high temperatures are especially damaging, because they are in the region of the weld point 11, which, as can be clearly seen for example in FIG. 5, during the welding is guided in a circle around the outer conductor 4 and the housing component 2 on their respective line of contact, with the result that both strong thermal and mechanical stresses occur between the outer conductor 4 and the insulating component 5 both during the heating induced by the welding operation and during subsequent cooling.

As a result, it is already possible for damage to occur in the feedthrough 1 that is not necessarily able to be identified immediately after the welding operation, but that can lead to a greatly shortened operational integrity of this feedthrough. For example, microscopic cracks formed during the welding operation can propagate to a gradually increasing extent and this can be made worse by later mechanical and thermal loading of the feedthrough, and consequently can lead to failure of the feedthrough, for instance owing to a no longer sufficiently retained inner conductor 3.

Substantially more advantageous conditions are, however, enabled by the embodiments provided according to the invention, which are improved over the prior art and are explained below, without restricting generality, initially only with reference to FIGS. 10 and 11 but are also implemented by the further embodiments disclosed herein.

The heat resulting at the weld point 13 during the welding operation is initially introduced not into the outer conductor 4 but into the respective sleeve 6, from where it is only then conducted further to the outer conductor 4 and only to a considerably reduced extent in relation to the conventional feedthroughs. The maximum temperature Tmax of the outer conductor 4, on the inner face or inner surface of the outer conductor 4 that is connected to the insulating component 5, was only approximately 100° C. immediately after the laser welding, which was performed under the same conditions as the laser welding described above of a conventional feedthrough.

In the case of TIG welding, which was likewise performed under the same conditions as the TIG welding described above of a conventional feedthrough, these maximum temperatures Tmax were only approximately 139° C. on the inner face or inner surface of the outer conductor 4 that is connected to the insulating component 5.

In addition to the greatly reduced thermal stresses, it was also possible to greatly reduce mechanical stresses exerted on the insulating component 5 by the outer conductor 4, since these stresses were able to relax substantially already in the sleeve 6.

In this respect, by contrast to mechanical stresses, which are caused by forces exerted on the insulating component 5 by the outer conductor 4, thermal stresses are understood to mean those stresses generated by the respective temperature gradients in the respective component itself, that is in the outer conductor 4 and the insulating component 5 itself.

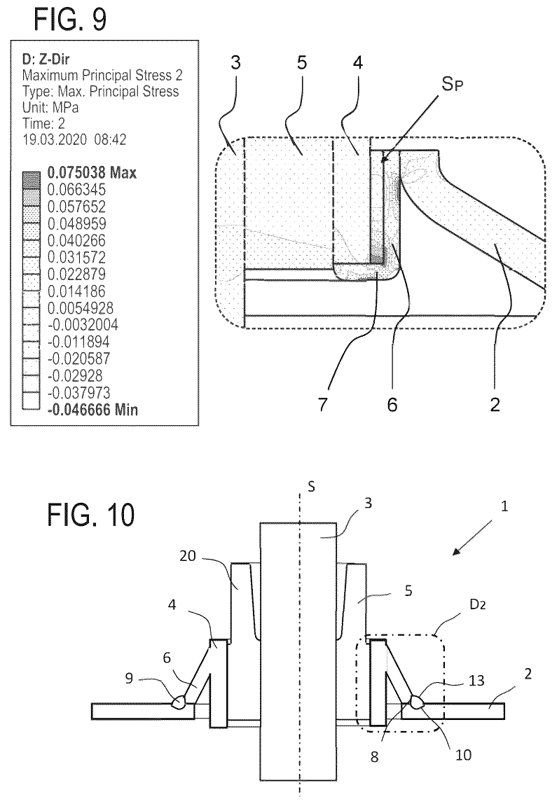

Very advantageously, it was also possible to greatly improve the damping of the deflection of the inner conductor 3, which is optionally in the form of a cylindrical peg or pin, relative to the outer conductor 4 with respect to vibrations, as will be described in more detail below with reference to FIGS. 8 and 9.

The vibrations introduced into the inner conductor 3 in the case of the conventional feedthrough, illustrated in FIGS. 3 and 4, act directly on the insulating component 5, and via the latter directly on the outer conductor 4, through this feedthrough. If further components, for example connectors, in particular plug-in or screw connectors, generally with their respective associated connecting lines, are arranged for example on the inner conductor 3, they can exert considerable forces on the inner conductor 3, for example during operation of a motor vehicle, if the feedthrough is fastened to a housing component of a functional assembly of the exhaust gas system of this motor vehicle. The rigid connection to the housing component 2, however, means it is necessary for these forces to be completely taken up by the inner conductor 3

In the case of the embodiments provided according to the invention, however, the sleeve 6 can largely elastically take up such vibration-induced forces and as a result greatly decrease the forces acting on the inner conductor 3.

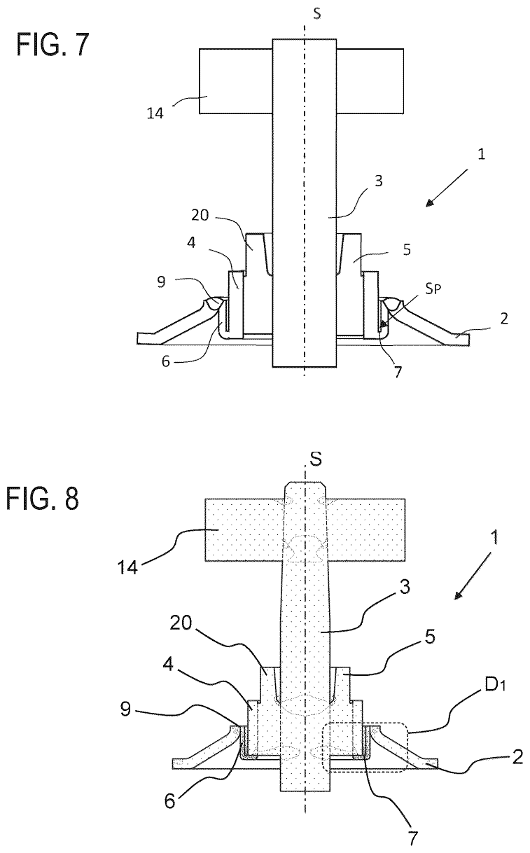

In the case of the feedthroughs illustrated in FIGS. 7, 8 and 9, at the upper end of its inner conductor 3 a respective mechanical actuator 14 was attached, which introduced vibrations into the feedthroughs that led to maximum accelerations of approximately 13 g (thus thirteen times the acceleration of the earth's gravitational field at sea level), which for routine applications for such feedthroughs are considerably above their operating loads.

It can be seen in the illustration of FIG. 8, which illustrates the resulting stresses, that only low stresses arise within the inner conductor 3, the insulating component 5 and in the outer conductor 4.

FIG. 9, which shows an enlarged view of the detail D₁ of FIG. 8 in the region of the transition from the outer conductor 4 to the sleeve 6, discloses that mechanical stresses arise substantially only in the sleeve 6 and in the radially inwardly extending bridge portion 7, which connects the sleeve 6 to the outer conductor 5 in one piece, and the lower portion of the outer conductor 4, and small stresses that are still introduced into the insulating component 5 are to be classified as uncritical for the insulating component 5, since their maximum is less than 0.23 MPa.

It was also possible for the respective sleeve 6 to achieve substantially the same improvements with the further embodiments disclosed here, with in this case the selection of the thickness of the cylindrical region D_{A} of the outer conductor 4 relative to the thickness D_{H} of the cylindrical region of the sleeve 6 being especially important; see for example FIG. 2. In this respect, the thickness of the cylindrical region D_{A} of the outer conductor 4 should optionally be approximately twice to four times the thickness D_{H} of the cylindrical region of the sleeve 6 and the axial extent E_{H} of the cylindrical region of the sleeve 6 should optionally be approximately three to ten times the thickness D_{H} of the cylindrical region of the sleeve 6. In the exemplary embodiments, the axial extent E_{H} of the cylindrical region of the sleeve 6 was less than the axial extent E_{A} of the cylindrical region of the outer conductor 4.

It may be generally advantageous if the sleeve 6 forms a gap Sp between the outer lateral surface of the outer conductor 4 and an inner surface of the sleeve 4, in order in this way to ensure that there is no damage to the outer conductor 4 and the sleeve 6 in the event of vibrations, or forces that act on the inner conductor 3 and trigger a tilting movement.

In further embodiments, illustrated in FIGS. 1 and 12 to 17, the sleeve 6 and the outer conductor 4 each have a two-piece form and the sleeve 6 surrounds the outer lateral surface of the outer conductor and has at least two spatially separate mounting regions 15, 16.

Advantageously, in these embodiments, different material can be used for the outer conductor and for the sleeve 6. Independently of one another, the material of the sleeve 6 or the outer conductor 4 can consist of or comprise metal, in particular iron, an iron alloy, an iron-chromium alloy, an iron-chromium-nickel alloy, an iron-nickel alloy or an iron-nickel-cobalt alloy, Kovar, titanium, a titanium alloy, in particular a metal from the group of steels, for example standard steels, stainless steels, nonrusting steels and high-temperature-stable ferritic steels, which are also known under the trade name Thermax, for example Thermax 4016, Thermax 4742, or Thermax 4762 or Crofer22 APU or Crofer22 H or NiFe-based materials, for example NiFe45, NiFe47 or those known under the trade name Inconel, for example Inconel 718 or X-750, or steels known for example under the designations CF25, Alloy 600, Alloy 625, Alloy 690, SUS310S, SUS430, SUH446 or SUS316, or austenitic steels such as 1.4828 or 1.4841, aluminum, an aluminum alloy, AlSiC, magnesium or a magnesium alloy.

Generally, in the case of the two-piece embodiments, the first mounting region 15 provides a mechanical connection between the sleeve 6 and the outer conductor 4 and the second mounting region 16 provides a mechanical connection between the sleeve 6 and the housing component 2 of the functional assembly, for example an exhaust gas system of a motor vehicle. Optionally, the first mounting region 15 is formed on the inner surface of the sleeve 6 and the second mounting region 16 is formed on an outer lateral surface of the sleeve 6.

In this case, optionally the second mounting region 16 is radially and/or axially offset relative to the first mounting region 15.

In the embodiment illustrated in FIG. 1, the first mounting region 15 is formed, for example, by friction welding the sleeve 6, which in this case has a radially narrowed portion optionally in its lower region, and the second mounting region 16 comprises a welded connection, in particular a TIG- or laser-welded connection, as was already described above for the one-piece embodiments.

In general, however, the first mounting region 15, which provides a mechanical connection between the outer conductor 4 and the sleeve 6, in the mounted state may be retained on the sleeve 6, in particular on a mounting region 17 of the sleeve 6, by a soldered connection or a welded connection, in particular a resistance-welded, friction-welded, laser-welded or TIG-welded connection or by friction welding.

In some embodiments, in the mounted state the first mounting region 15 may also be retained on the sleeve 6, in particular on a mounting region 17 of the sleeve 6, by a press fit or by mechanical pressing elements, in particular by recesses at certain points or certain regions of the sleeve 6 in the radially inward direction.

Below, reference will be made to the embodiments illustrated in FIGS. 12 to 17, in which, for the sake of simplicity of illustration, the housing component 2 is not shown, but nevertheless the location at which it is to be attached to the second mounting region 16 is shown.

In the embodiment of the outer conductor 4 and the sleeve 6 illustrated in FIG. 12, the sleeve 6 has a projecting bottom region 18 and the sleeve 6 is retained, by way of its projecting bottom region 18, on the outer conductor 6 by an annular weld seam 19 generated by laser welding.

In this embodiment and the embodiments described below, the insulating component does not have a creep distance extension 20, which extends upward substantially annularly around and at a distance from the inner conductor 3 and brings about an enlargement of the surface between the inner conductor 3 and the outer conductor 4 along the upper surface of the insulating component 5, but the substantially planar upper surface 21 of the insulating component 5 extends substantially parallel to its likewise planar lower surface 22.

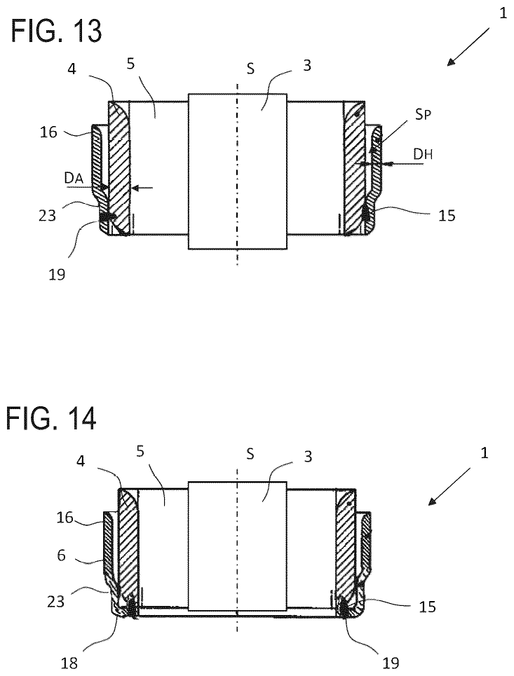

The embodiments illustrated in FIGS. 13 to 17 each have, in the lower region of the sleeve 6, a radially narrowed portion 23 of the sleeve 6 in the region of the first mounting portion 15, which radially narrowed portion can securely retain the outer conductor 4 already owing to frictional forces, in particular while the feedthrough 1 is being mounted.

FIG. 13 shows a cross-sectional illustration of the outer conductor 4 and the sleeve 6 of a further embodiment, in which the sleeve 6 does not have a projecting bottom region 18 and a weld seam 19 is attached to the outer conductor 4 and the sleeve 6 by laser welding and extends laterally in the lower, radially narrowed portion 23.

In the embodiment of the outer conductor 4 and the sleeve 6 with a radially projecting bottom portion 18 and a radially narrowed portion 23 that is illustrated in FIG. 14, in the region of the first mounting portion 15 of the sleeve a weld seam 19 is attached to the outer conductor 4 and the sleeve 6 by laser welding and extends laterally in the radially projecting bottom portion 18.

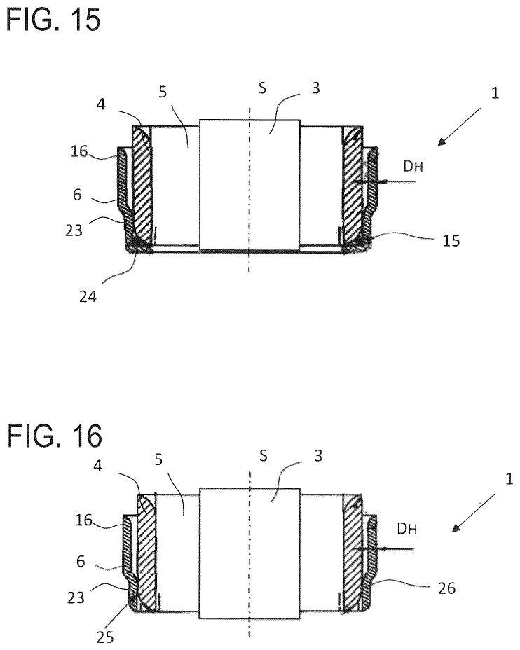

FIG. 15 shows an embodiment of the outer conductor 4 and the sleeve 6 with a projecting bottom region 18 and a radially narrowed portion 23 in the region of the first mounting portion of the sleeve, in which the sleeve 6 is retained on the outer conductor 4 by a soldered connection 24. In this embodiment, the soldered connection 24 can advantageously be produced at the same time as and thus during the vitrification of the insulating component 5, since the temperatures required for the vitrification can reliably liquefy the solder used. To this end, the radially narrowed portion of the sleeve 6 together with the outer conductor forms an annular cavity in which the solder can be placed before the vitrification and which contains the soldered connection 24 after the vitrification.

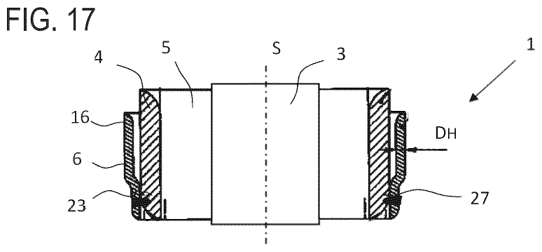

FIG. 16 shows an embodiment of the outer conductor 4 and the sleeve 6 with a radially narrowed portion 23 in the region of the first mounting portion 15, in which the sleeve 5 is retained on the outer conductor 4 by a press fit 25 and/or by mechanical pressing elements, in particular by recesses 26 at certain points or certain regions of the sleeve 6 in the radially inward direction.

FIG. 17 discloses an embodiment of the outer conductor 4 and the sleeve 6 with a radially narrowed portion 23 in the region of the first mounting portion 15, in which the sleeve is retained on the outer conductor by welded connections 27 at certain points.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

1 Feedthrough in a housing component 2
2 Housing component
3 Inner conductor
4 Outer conductor
5 Electrically insulating component
6 Sleeve
7 Radially inwardly extending bridge portion, which connects the sleeve 6 to the outer conductor 5 in one piece
8 Mounting region for those embodiments in which the outer conductor and the sleeve are formed in one piece
9 Weld seam
10 Mounting region of the housing component 2
11 Weld point
12 Weld seam of a conventional feedthrough
13 Weld point in the embodiments disclosed here
14 Mechanical actuator
15 First mounting region
16 Second mounting region
17 Mounting region of the sleeve 6
18 Projecting bottom region of the sleeve 6
19 Weld seam, in particular laser weld seam
20 Creep distance extension
21 Substantially planar upper surface of the insulating component 5
22 Planar lower surface of the insulating component 5
23 Radially narrowed portion of the sleeve 6 in the region of the first mounting portion 15
24 Soldered connection
25 Press fit
D₁ Detail of FIG. 8
D₂ Detail of FIG. 10
D_{A} Thickness of the cylindrical region of the outer conductor 4
D_{H} Thickness of the cylindrical region of the sleeve 6
E_{A} Axial extent of the cylindrical region of the outer conductor 4
E_{H} Axial extent of the cylindrical region of the sleeve 6
S Line of symmetry

What is claimed is:

1. A feedthrough in a housing component that is subject to thermal loading for a functional assembly, the feedthrough comprising:
an inner conductor;
an outer conductor having a sleeve assigned to or formed on the outer conductor that retains or makes it possible to fasten the feedthrough to the housing component; and
an electrically insulating component between the outer conductor and the inner conductor, the electrically insulating component retaining the inner conductor relative to the outer conductor in an electrically insulated fashion.

2. The feedthrough of claim 1, wherein the inner conductor has a cylindrically symmetrical form and the outer conductor cylindrically symmetrically surrounds the inner conductor.

3. The feedthrough of claim 1, wherein the sleeve surrounds an outer lateral surface of the outer conductor and has at least two spatially separate mounting regions or the sleeve is formed in one piece with the outer conductor and forms at least one mounting region.

4. The feedthrough of claim 3, wherein a first mounting region provides a mechanical connection between the sleeve and the outer conductor and a second mounting region provides a mechanical connection between the sleeve and the housing component of the functional assembly.

5. The feedthrough of claim 4, wherein the sleeve has a radially narrowed portion in a region of the first mounting region.

6. The feedthrough of claim 4, wherein the first mounting region is formed on an inner surface of the sleeve and the second mounting region is formed on an outer lateral surface of the sleeve.

7. The feedthrough of claim 4, wherein the second mounting region is radially and/or axially offset relative to the first mounting region.

8. The feedthrough of claim 4, wherein the second mounting region provides a mechanical connection to the housing component of the functional assembly of an exhaust gas system of a motor vehicle in a mounted state and is connected to the housing component of the functional assembly of the exhaust gas system of the motor vehicle by a soldered connection or a welded connection.

9. The feedthrough of claim 4, wherein the first mounting region, which provides a mechanical connection between the outer conductor and the sleeve in a mounted state is formed by a soldered connection or a welded connection on the sleeve and is retained on a mounting region of the sleeve.

10. The feedthrough of claim 4, wherein the first mounting region, which provides a mechanical connection between the outer conductor and the sleeve in a mounted state is retained on the sleeve by a press fit or by a mechanical pressing element.

11. The feedthrough of claim 10, wherein a coefficient of thermal expansion of material of the outer conductor is less than a coefficient of thermal expansion of material of the sleeve.

12. The feedthrough of claim 4, wherein a fastener on the first mounting region has a radially encircling form and an annularly closed fastening line formed on the first mounting region is offset in relation to a lower radial end and an upper radial end of the sleeve.

13. The feedthrough of claim 4, wherein the second mounting region formed on an outer lateral surface of the sleeve has an encircling form, wherein an annularly closed fastening line formed on the second mounting region is offset in relation to a lower radial end and an upper radial end of the sleeve.

14. The feedthrough of claim 1, wherein the sleeve forms a gap between an outer lateral surface of the outer conductor and an inner surface of the sleeve.

15. The feedthrough of claim 1, wherein a material of the sleeve consists of or comprises at least one of a metal, iron, an iron alloy, an iron-chromium alloy, an iron-chromium-nickel alloy, an iron-nickel alloy, an iron-nickel-cobalt alloy, Kovar, titanium, a titanium alloy, steel, standard steel, stainless steel, nonrusting steel, high-temperature-stable ferritic steel, NiFe-based material, NiFe45, NiFe47, austenitic steel, aluminum, an aluminum alloy, AlSiC, magnesium, or a magnesium alloy.

16. The feedthrough of claim 1, wherein a material of the outer conductor consists of or comprises a metal, iron, an iron alloy, an iron-chromium alloy, an iron-chromium-nickel alloy, an iron-nickel alloy, an iron-nickel-cobalt alloy, Kovar, titanium, a titanium alloy, steel, standard steel, stainless steel, nonrusting steel, high-temperature-stable ferritic steel, NiFe-based material, NiFe45, NiFe47, austenitic steel, aluminum, an aluminum alloy, AlSiC, magnesium, or a magnesium alloy.

17. The feedthrough of claim 1, wherein a thickness of a cylindrical region of the outer conductor is approximately twice to four times a thickness of a cylindrical region of the sleeve and an axial extent of the cylindrical region of the sleeve is approximately three to ten times the thickness of the cylindrical region of the sleeve.

18. The feedthrough of claim 17, wherein the axial extent of the cylindrical region of the sleeve is less than an axial extent of the cylindrical region of the outer conductor.

19. The feedthrough of claim 1, wherein the functional assembly is an exhaust-gas catalytic converter or a turbocharger.

20. The feedthrough of claim 1, wherein the housing component subject to thermal loading is part of a chemical production plant.
